(19) United States
(12) Patent Application Publication
(10) Pub. No.: US 2025/0258060 A1
(43) Pub. Date: Aug. 14, 2025

(54) Method And Device For Predicting Service Life Of Rolling Bearing

(71) Applicant: Siemens Aktiengesellschaft, München (DE)

(72) Inventors: Bin Zhang, Beijing (CN); Armin Roux, Höchstadt a. d. Aisch (DE); Shun Jie Fan, Beijing (CN); Ji Li, Beijing (CN)

(73) Assignee: Siemens Aktiengesellschaft, München (DE)

(21) Appl. No.: 19/099,266

(22) PCT Filed: Jul. 29, 2022
(86) PCT No.: PCT/CN2022/109204

§ 371 Date: Jan. 28, 2025

(51) Int. Cl. G01M 13/045

(52) U.S. Cl. CPC G01M 13/045

(57) ABSTRACT

Various embodiments of the teachings herein include a method for predicting service life of a rolling bearing. An example includes: acquiring a first vibration signal of a rolling bearing; extracting a time-domain feature of the first vibration signal, wherein the time-domain feature represents a degradation state of the rolling bearing; entering the time-domain feature into a trained Seq2Seq model comprising an encoder and a decoder, the encoder comprising a bidirectional gated recurrent unit (BIGRU), the decoder comprising a long short-term memory model (LSTM), the BIGRU adapted to output a hidden state based on the time-domain feature, the LSTM is adapted to predict service life of the rolling bearing based on the hidden state; and generating the service life.

### CROSS-REFERENCE TO RELATED APPLICATIONS

This application is a U.S. National Stage Application of International Application No. PCT/CN2022/109204 filed Jul. 29, 2022, which designates the United States of America, the contents of which are hereby incorporated by reference in their entirety.

### TECHNICAL FIELD

The present disclosure relates to artificial intelligence (AI). Various embodiments of the teachings herein include methods and/or devices for predicting service life of rolling bearing.

### BACKGROUND

Rolling bearing is an important transmission component of mechanical equipment and its working condition has a great impact on the equipment. The failure of rolling bearings often reduces the reliability and accuracy of equipment, which not only affects production, reduces the service life of equipment, but also causes accidents. Therefore, it is of great significance to predict the service life of rolling bearings.

In recent years, many scholars have devoted themselves to research on the service life prediction of rolling bearings. The existing methods include physical methods based on models, statistical methods, and artificial intelligence methods based on data.

However, the service state of rolling bearings changes with time, and the data at the previous time has a certain impact on the prediction results at the later time. The general physical methods based on models, statistical methods, and artificial intelligence methods based on data are not ideal in the processing of timing characteristics of rolling bearings.

### SUMMARY

The teachings of the present disclosure include methods and devices for predicting service life of rolling bearing. For example, some embodiments include a method for predicting service life of a rolling bearing comprising: acquiring a first vibration signal of a rolling bearing; extracting a time-domain feature of the first vibration signal, wherein the time-domain feature represents a degradation state of the rolling bearing; inputting the time-domain feature into a trained Seq2Seq model, the Seq2Seq model comprising an encoder and a decoder, the encoder comprising a bidirectional gated recurrent unit (BIGRU), the decoder comprising a long short-term memory model (LSTM), the BIGRU is adapted to output a hidden state based on the time-domain feature, the LSTM is adapted to predict service life of the rolling bearing based on the hidden state; and outputting the service life.

In some embodiments, the encoder further comprising a convolutional neural network, the output of the convolutional neural network relates to the input of the BIGRU, and the convolutional neural network is adapted to perform feature compression on the time-domain feature.

In some embodiments, outputting the hidden state based on the time-domain feature comprising: Obtaining a forward hidden state through a forward time cycle layer; Obtaining a reverse hidden state through a reverse time cycle layer; splicing the forward hidden state and the reverse hidden state to obtain the hidden state.

In some embodiments, the decoder further comprises an attention mechanism, the output of the attention mechanism relates to the input of the LSTM, and the attention mechanism is adapted to perform weighted summation of the hidden state.

In some embodiments, the method further comprises: acquiring a second vibration signal of the rolling bearing; dividing the second vibration signal into a train set and a test set; training the Seq2Seq model based on the train set; and using the test set to test the Seq2Seq model trained based on the train set.

In some embodiments, training the Seq2Seq model based on the train set comprises: taking RMSE (Root Mean Square Error) as the loss function of the training, wherein

$$RMSE = \sqrt{\frac{1}{n} {\sum }_{i = 1}^{n} {( {\hat{y}}_{i} - {y}_{i} )}^{2}} ;$$

wherein n is the number of training samples in the train set; i is the index of training samples; ŷᵢ is predicted value of service life; yᵢ is actual value of service life.

In some embodiments, using the test set to test the Seq2Seq model trained based on the train set comprises: taking MAE (Mean-Absolute-Error) as evaluation function of the testing, wherein

$$MAE = \frac{1}{n} {\sum }_{i = 1}^{n} \vert {\hat{y}}_{i} - {y}_{i} \vert ;$$

wherein n is the number of testing samples in the test set; i is the index of testing samples; ŷᵢ is predicted value of service life; yᵢ is actual value of service life.

In some embodiments, the method further comprises: denoising the second vibration signal with discrete wavelet changes; and performing rolling segmentation on the denoised second vibration signal based on window length of a preset sliding window.

In some embodiments, the time-domain feature comprises at least one of the following: mean value; variance; root mean square amplitude; root mean square value; maximum value; minimum value; waveform index; peak index; pulse index; marginal index; skewness; and kurtosis.

As another example, some embodiments include a device for predicting service life of a rolling bearing comprising: an acquiring module, configured to acquire a first vibration signal of a rolling bearing; an extracting module, configured to extract a time-domain feature of the first vibration signal, wherein the time-domain feature represents a degradation state of the rolling bearing; an inputting module, configured to input the time-domain feature into a trained Seq2Seq model, the Seq2Seq model comprising an encoder and a decoder, the encoder comprising a BIGRU, the decoder comprising a LSTM, the BIGRU is adapted to output a hidden state based on the time-domain feature, the LSTM is adapted to predict service life of the rolling bearing based on the hidden state; and an outputting module, configured to output the service life.

As another example, some embodiments include an electronic device comprising: a processor and a memory, wherein an application program executable by the processor is stored in the memory for causing the processor to execute one or more of the methods for predicting service life of a rolling bearing described herein.

As another example, some embodiments include a computer-readable medium storing computer-readable instructions thereon, wherein the computer-readable instructions for executing a method for predicting service life of a rolling bearing according to any one of above.

As another example, some embodiments include a computer program product comprising a computer program, when the computer program is executed by a processor for executing one or more of the methods for predicting service life of a rolling bearing described herein.

Example embodiments of the teachings herein include a Seq2Seq structure for bearing life prediction. The Seq2Seq network integrates artificial and convolution feature extraction increases the interpretability of features. The length definition of input and output of the model is flexible and model performance is improved.

### BRIEF DESCRIPTION OF THE DRAWINGS

In order to make technical solutions of examples of the present disclosure clearer, accompanying drawings to be used in description of the examples will be simply introduced hereinafter.

Obviously, the accompanying drawings to be described hereinafter are only some examples of the present disclosure. Those skilled in the art may obtain other drawings according to these accompanying drawings without creative labor.

FIG. 1 is a flowchart of an example method for predicting service life of rolling bearing incorporating teachings of the present disclosure;

FIG. 2 is a schematic diagram of an example prediction process of service life of rolling bearing incorporating teachings of the present disclosure;

FIG. 3 is a schematic diagram of an example training process and testing process of service life prediction model of a rolling bearing incorporating teachings of the present disclosure;

FIG. 4 is an exemplary line diagram of loss values;

FIG. 5 is an exemplary structure diagram of an example device for predicting service life of rolling bearing incorporating teachings of the present disclosure; and

FIG. 6 is an exemplary configuration diagram of an electronic device incorporating teachings of the present disclosure.

### LIST OF REFERENCE NUMBERS

| reference numbers | meanings |
|---|---|
| 101~103, 40~43 | steps |
| 20 | vibration signal |
| 21 | time-domain features |
| 22 | test data |
| 23 | encoder |
| 24 | convolutional neural network |
| 25 | attention mechanism |
| 26 | weighted sum of hidden states |
| 27 | LSTM |
| 28 | output layer |
| 29 | decoder |
| 44 | train set |
| 45 | position close to the end point |
| 46 | forward propagation |
| 47 | Seq2Seq model |
| 48 | predicted residual life |
| 49 | back propagation |
| 50 | test set |
| 60 | train loss |
| 61 | validation loss |
| 62 | test loss |
| 500 | device for predicting service |
| | life of rolling bearing |
| 501 | acquiring module |
| 502 | extracting module |
| 503 | inputting module |
| 600 | electronic device |
| 601 | processor |
| 602 | memory |

### DETAILED DESCRIPTION

In order to make the purpose, technical scheme, and advantages of the teachings herein more clear, the following examples are given to further explain the invention in detail. In order to be concise and intuitive in description, the teachings are illustrated below by describing several representative embodiments. Many details in the embodiments are only used to help. However, the teachings herein are not limited to these details. In order to avoid unnecessarily blurring the scheme, some embodiments are not described in detail, but only the framework is given. Hereinafter, “including” refers to “including but not limited to”, “according to . . . ” refers to “at least according to . . . , but not limited to . . . ”. Due to the language habits of Chinese, when the number of an element is not specifically indicated below, it means that the element can be one or more or can be understood as at least one.

Traditional feature extraction is aimed at the problem of sequence regression. In the process of learning and training, there are many problems, such as poor long-term dependence, weak core feature extraction ability, weak generalization ability, gradient disappearance and so on, which lead to the residual life prediction model cannot achieve expected diagnostic effect. The knowledge-based prediction method can combine case and rule reasoning according to expert system. However, it is only suitable for qualitative analysis, which requires high requirements for the establishment of knowledge base, and the maintenance cost of updating knowledge base is high, which is difficult to popularize in a large area. The data-based prediction method uses mathematical theory knowledge to limit and improve the computing power of the computer and the analysis ability based on data, so that the management and maintenance of equipment become information-based. However, due to the low standardization of bearing vibration signals and the excessive redundant data compared with the core features, the single cycle neural network can not be solved well.

Considering that signals in mechanical field are non-standardized, there are many redundant data, and there are some problems in feature extraction, such as low efficiency and inconvenient extraction. Traditional RNN or LSTM can only deal with the problem that the input and output are of fixed length, that is, one-to-one or many to many. The format of data input and output has certain limitations, and the generalization is not strong enough.

This disclosure provides a method for Seq2Seq cyclic network, which integrates artificial and convolutional feature extraction for life prediction. Seq2seq cyclic networks usually include encoder, decoder and fixed size state vectors connecting the two. By learning the input, the encoder encodes it into a fixed size state vector, and then transmits the state vector to the decoder, which outputs it by learning the state vector.

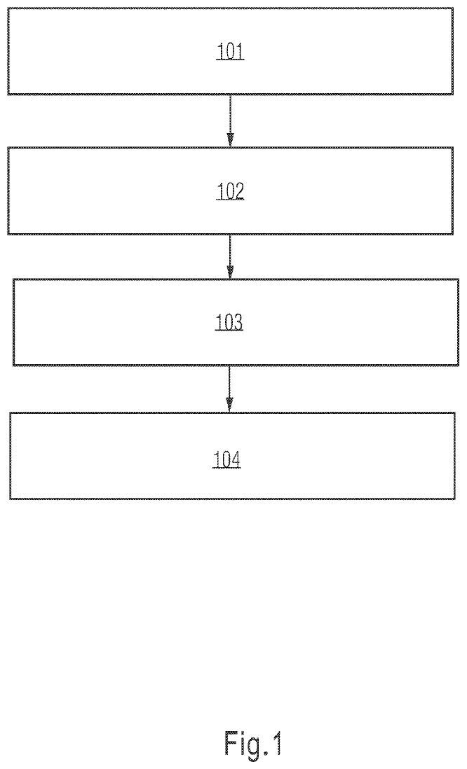

FIG. 1 is a flowchart of a method for predicting the service life of a rolling bearing incorporating teachings of the present disclosure. As shown in FIG. 1, the method comprises:

Step 101: Acquire a first vibration signal of a rolling bearing. Here, a vibration sensor can be used to acquire the first vibration signal of the rolling bearing. The first vibration signal is a signal used to predict the service life of the rolling bearing.

For example, the first vibration signal in analog format is collected by piezoelectric acceleration sensor, and then the first vibration signal in digital format that can be recognized by microcomputer is obtained by charge amplifier and A/D conversion circuit with filter. In some embodiments, the first vibration signal of the rolling bearing can be read from control system of motor, or the first vibration signal can be converted based on current value or torque value of drive motor. The first vibration signal may be a time series signal.

Step 102: Extract time-domain features of the first vibration signal, wherein the time-domain features represent degradation state of the rolling bearing. Here, time-domain features are extracted automatically or manually. In real-time dynamic detection process, time-domain features of the first vibration signal can directly reflect the degradation state of the bearing. In one embodiment, the time-domain features includes at least one of the following: mean value; Variance; Root mean square amplitude; Root mean square value; Maximum value; Minimum value; Waveform index; Peak index; Pulse index; Marginal index; Skewness; and Kurtosis.

Step 103: Input the time-domain features into a trained Seq2Seq model, the Seq2Seq model comprising an encoder and a decoder, the encoder comprising a bidirectional gated recurrent unit (BIGRU), the decoder comprising a long short-term memory model (LSTM), the BIGRU is adapted to output hidden states based on the time-domain features, the LSTM is adapted to predict service life of the rolling bearing based on the hidden states.

In some embodiments, outputting the hidden state based on the time-domain feature comprising: obtaining a forward hidden state through a forward time cycle layer; obtaining a reverse hidden state through a reverse time cycle layer; splicing the forward hidden state and the reverse hidden state to obtain the hidden state.

Gru (gated recurrent unit) is an optimization type of RNN. It alleviates the gradient disappearance problem of RNN through gating mechanism, so it could learn the long-term dependency existing in long sequences. However, the unidirectional Gru only learns the sequence information from the front to the back. In some problems, the output of present time is not only related to above sequence information but also related to the following sequence information. For example, when predicting the missing words in a sentence, we need to combine the above and following content at the same time. BIGRU is a kind of neural network that can deal with such problems. BIGRU is composed of two Gru cycle layers with opposite information transmission directions, in which the first layer transmits information in chronological order (forward time cycle layer) and the second layer transmits information in reverse time order (reverse time cycle layer). The basic idea of BIGRU is: get the forward hidden state through the forward time cycle layer, get the reverse hidden state through the reverse time cycle layer, and then splice the forward hidden state and the reverse hidden state to get the final output hidden state of BIGRU.

In some embodiments, the encoder further comprising a convolutional neural network, the output of the convolutional neural network relates to the input of the BIGRU, and the convolutional neural network is adapted to perform feature compression on the time-domain feature. Compressed features are provided to BIGRU. Therefore, the embodiment of the invention proposes a novel Seq2Seq structure for bearing life prediction. The Seq2Seq network integrating artificial and convolution feature extraction increases the interpretability of features. The length definition of input and output of the model is flexible and model performance is improved.

In some embodiments, wherein the decoder comprising an attention mechanism, the output of the attention mechanism relates to the input of the LSTM, and the attention mechanism is adapted to perform weighted summation of the hidden states. Weighted sum results of hidden states are provided to LSTM.

Based on weighted sum results of hidden states, LSTM predicts service life of the rolling bearing, preferably a residual service life. LSTM is a kind of time cyclic neural network, which is specially designed to solve the long-term dependence problem of general RNN. LSTM is a kind of neural network containing LSTM blocks or others. In literature or other materials, LSTM blocks may be described as intelligent network units, because it can remember values of variable length of time. A gate in the block can decide whether input is important enough to be remembered and whether output can be output.

Step 104: output the service life.

In some embodiments, the method further comprises: acquiring a second vibration signal of the rolling bearing; dividing the second vibration signal into a train set and a test set; training the Seq2Seq model based on the train set; using the test set to test the Seq2Seq model trained based on the train set. wherein training the Seq2Seq model based on the train set comprising: taking RMSE as the loss function of the training, wherein

$$RMSE = \sqrt{\frac{1}{n} {\sum }_{i = 1}^{n} {( {\hat{y}}_{i} - {y}_{i} )}^{2}} ;$$

wherein n is the number of training samples in the train set; i is the index of training samples; ŷᵢ is predicted value of service life; yᵢ is actual value of service life. Here, the second vibration signal is used to train and test the Seq2Seq model.

In some embodiments, using the test set to test the Seq2Seq model trained based on the train set comprises: taking MAE as evaluation function of the testing, wherein

$$MAE = \frac{1}{n} {\sum }_{i = 1}^{n} \vert {\hat{y}}_{i} - {y}_{i} \vert ;$$

wherein n is the number of testing samples in the test set; i is the index of testing samples; ŷᵢ is predicted value of service life; yᵢ is actual value of service life.

In some embodiments, the method further comprises: denoising a second vibration signal with discrete wavelet changes; and performing rolling segmentation on the denoised second vibration signal based on window length of a preset sliding window.

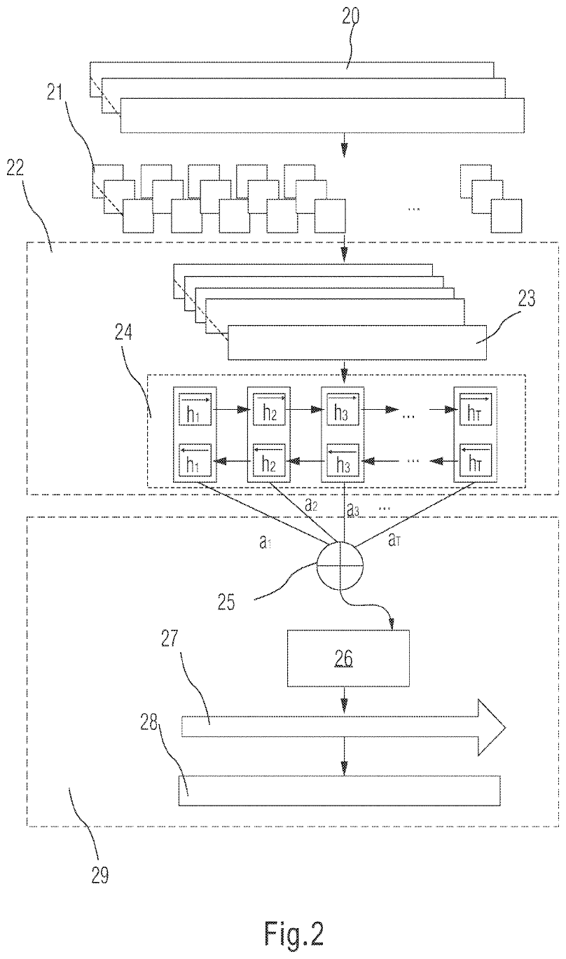

FIG. 2 is a schematic diagram of an example prediction process of the service life of a rolling bearing incorporating teachings of the present disclosure. As shown in FIG. 2, a Seq2Seq cyclic network integrating artificial and convolution feature extraction and attention mechanism is illustrated. The Seq2Seq model includes an encoder 22 and a decoder 29. The Residual life prediction algorithm of Seq2Seq cyclic network integrating artificial and convolution feature extraction and attention mechanism specifically uses the following steps, and the implementation process is shown in FIG. 2, where parameter number ‘h’ represents hidden layer features of BIGRU. For example, it is shown as h1, h2, ha3 . . . in FIG. 2. Parameter number ‘a’ represents attention weights of attention mechanism. For example, it is shown as a1, a2, a3 . . . in FIG. 2.

First, collect the vibration signal 20 of the rolling bearing. Then, time-domain features of the vibration signal 20 are extracted. For example, the following 12 time-domain features 21 of the vibration signals 20 are extracted: mean value; Variance; Root mean square amplitude; Root mean square value; Maximum value; Minimum value; Waveform index; Peak index; Pulse index; Marginal index; Skewness; and Kurtosis.

Next, respective time series data of the time-domain features 21 are sent to the encoder 22 of the Seq2Seq model. The encoder 22 includes one or more convolutional neural networks 23. One or more convolutional neural networks 23 perform feature compression on the time-domain features 21 to reduce the total length of the time series to an appropriate size to reduce the impact of gradient disappearance or explosion on the cyclic neural network. The output signal of convolutional neural network 23 is transmitted to BIGRU 24. BIGRU 24 outputs hidden-layer states based on the time-domain features 21. BIGRU 24 sends the hidden-layer states to decoder 29. The attention mechanism 25 in the decoder 29 performs a weighted sum of the hidden-layer states. Weighted sums of hidden states are provided to LSTM 27. LSTM 27 predicts the service life of rolling bearings based on weighted sums 26 of hidden states. The output layer 28 outputs the service life.

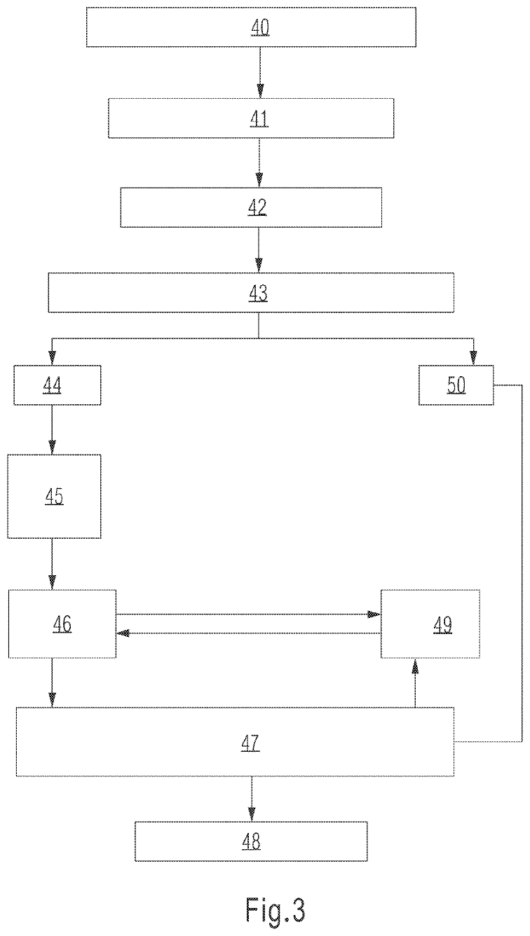

FIG. 3 is a schematic diagram of an example training process and testing process of the service life prediction model of a rolling bearing incorporating teachings of the present disclosure. The training process and testing process comprises:

Step 40: acquire vibration signals of the bearing.

Step 41: perform wavelet analysis and denoising on the vibration signals.

Step 42: perform equally spaced sampling on the denoised vibration signals.

Step 43: the vibration signals sampled at equal intervals perform rolling segmentation to form a training set 44 and a test set 50, according to the window length of the preset sliding window.

For the test set 44, the position 45 close to the end point is randomly selected and input into the Seq2Seq model 47 with the architecture shown in FIG. 2. The forward propagation 46 and prediction of residual service life 48 are performed in the Seq2Seq model 47. Moreover, the back propagation 49 is performed in the Seq2Seq model 47, a loss function value is determined based on the difference between predicted residual life 48 and actual residual life, and the model parameters of the Seq2Seq model 47 are adjusted by the loss function value.

Input the test set 50 into the trained Seq2Seq model 47 and output predicted residual life during testing process.

In general, this example method includes:

### (1).□Characteristic Calculation of Time Series Data Based on Common Time Domain Indexes of Vibration Signal.

In some embodiments, 12 items such as mean value, variance, root square amplitude, root mean square value, maximum value, minimum value, waveform index, peak index, pulse index, margin index, skewness and kurtosis are selected as time series data for calculation. Since the source data includes vibration signals divided into horizontal and vertical directions.

(2). □Encoder and Decoder of Seq2Seq Cyclic Network with Artificial and Convolution Feature Extraction and Attention Mechanism.

The network main body Seq2Seq model is based on the coding decoding structure. Firstly, the coding process is that the convolution layer acts as a feature compressor to reduce the total length of the sequence to an appropriate size, to reduce the influence of gradient disappearance or explosion in the cyclic neural network. Then, the feature sequence is viewed by using the bidirectional gated cyclic unit network, and the hidden state (HT) is output.

Finally, the decoding process is that the LSTM network acts as a decoder to gradually predict the hidden layer eigenvalues representing the health indicator (HI). In each step, the attention score obtained according to the presentation of the overall information provided by the encoder is helpful to find out the most important information. The structural parameters of Seq2Seq network integrating artificial and convolution feature extraction and attention mechanism are shown in Table 1.

TABLE 1
Network structure parameters
Network structure parameters

| | | | |
|---|---|---|---|
| Coding | Convolutional | Convolution kernel | 64 |
| structure | compression | size | |
| | characteristics | step | 8 |
| | | Number of Input | 24 |
| | | channels | |
| | | Number of Output | 64 |
| | | channels | |
| | | Activation | PRelu |
| | | function | |
| | Bi-GRU | Hidden layer | 200 |
| | | sequence length | |
| | | Weight | 1 |
| | | initialization | |
| Decoding | Attention-LSTM | Sequence length | 200 |
| structure | | Attention | Direct |
| | | mechanism adding | splicing |
| | | mode | |
| — | loss | MAE (Mean Absolute | — |
| | | Error) | |
| | | RMSE (Root Mean | — |
| | | Square Error) | |
| — | optimizer | Adam | Lr = 0.005 |

### (3). Overall Flow Chart of Residual Life Prediction Algorithm

A Seq2Seq cyclic network integrating artificial and convolution feature extraction and attention mechanism is proposed. The training process and testing process as shown in FIG. 3.

### (4). Model Optimization and Training

In the input layer, the characteristic data are standardized to accelerate the convergence of the model. In the coding process, firstly, the convolution layer is used as the feature compressor to reduce the total length of the sequence to an appropriate size, to reduce the influence of gradient disappearance or explosion in the cyclic neural network and adjust the weight and bias through back propagation to minimize the error between the output data and the expected data. Finally, the decoding process is that the LSTM network acts as a decoder to gradually predict the hidden layer eigenvalues representing the health indicator (HI).

The purpose of training is to reduce the value of constructing loss function. The training process takes the root mean square error (RMSE) as the loss function, that is, the mean square error (MSE) with root sign. The larger the error is, the larger its value is. Finally, the average absolute error (MAE) is used as the index to measure the model. When the predicted value is completely consistent with the actual value, it is equal to 0, which is the perfect model. Similarly, the greater the error, the greater the value. The two formulas are as follows:

$$MAE = \frac{1}{n} {\sum }_{i = 1}^{n} \vert {\hat{y}}_{i} - {y}_{i} \vert ; RMSE = \sqrt{\frac{1}{n} {\sum }_{i = 1}^{n} {( {\hat{y}}_{i} - {y}_{i} )}^{2}} .$$

### (5). Analysis of Experimental Results

In order to verify the superiority of the Seq2Seq cyclic network model of the present invention (hereinafter referred to as TCA-Seq2Seq) integrating artificial and convolutional feature extraction and attention mechanism, several comparative experiments were designed and tested on phm2012 data set. The results are shown in Table 2. In Table 2, A-GRU represents gating cycle unit model based on attention mechanism. T-LSTM represents model using the combination of temporal features and long-term and short-term memory units. Seq2seq represents the structure of encoding and decoding structure, BIGRU as the encoding part and LSTM as the decoding part. TC-Seq2Seq represents the feature extraction part based on the combination of the time-domain features of the vibration signal and the convolution compression features of the above Seq2Seq, and TCA-Seq2Seq represents the attention calculation in the encoding and decoding process based on the above TC-Seq2Seq.

The experimental results show that compared with BIGRU model, the error of Seq2Seq model with LSTM decoding is reduced by 0.04. The TC-Seq2Seq model of the feature extraction part of the combination of time-domain features of vibration signal and convolution compression features is added, and the error is reduced by 0.05 compared with Seq2Seq model. Compared with the TC-Seq2Seq model, the error of TCA-Seq2Seq with attention mechanism is reduced by 0.04. Compared with A-GRU, TCA-Seq2Seq error is reduced by 0.07. Compared with T-LSTM, TCA-Seq2Seq error is reduced by 0.13. The comparison shows that the TCA-Seq2Seq algorithm designed in this subject presents a good effect in the remaining life prediction, which reflects the advantages of the TCA-Seq2Seq algorithm designed in this subject in the remaining life prediction.

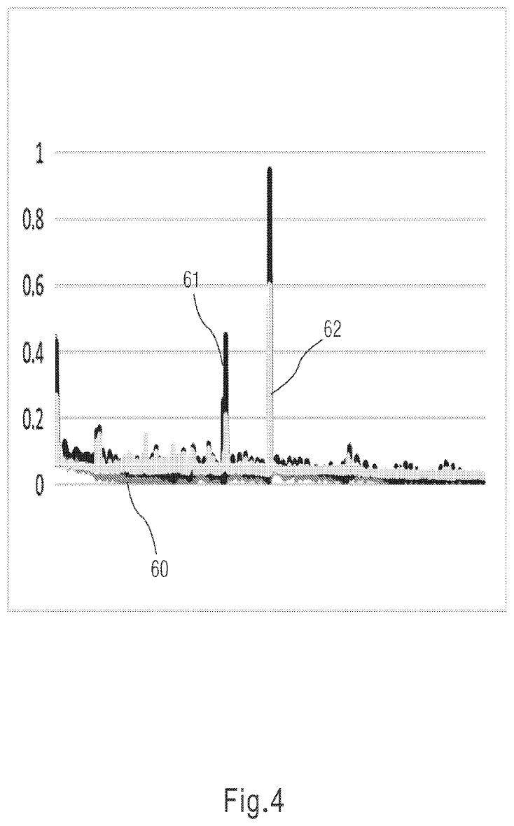

Taking MAE (Mean-Absolute-Error) as the loss value index, the loss value of specific training process, evaluation process and test process can reach a good convergence level, as shown in FIG. 4. FIG. 4 is an exemplary line diagram of loss values according to an embodiment of the present invention. The horizontal axis represents time, and the vertical axis represents loss value. Among them, train loss 60, validation loss 61 and test loss 62 are shown in FIG. 4.

TABLE 2
Experimental comparison results

| Model | MAE |
|---|---|
| TCA-Seq2Seq | 0.0251 |
| TC-Seq2Seq | 0.0608 |
| Seq2Seq | 0.1149 |
| BIGRU | 0.1527 |
| A-GRU | 0.0938 |
| T-LSTM | 0.1579 |

Taking phm2012 bearing data set as verification, according to the average absolute error index, several different residual life prediction models of BIGRU, Seq2Seq, TC seq2seq and TCA Seq2Seq are compared. The results show that the TCA Seq2Seq model in this invention improves the ability of feature extraction and regression fitting and reflects the usability and superiority of this model.

The traditional RNN or LSTM can only deal with the problem that the input and output are fixed length, that is, one to one or many to many, while Seq2Seq can deal with one to many. It is also the most important variant of RNN: n vs m (the input and output sequence lengths are different). Add the attention mechanism to give higher weight to the attention part, to obtain more effective information.

By using the teacher forcing mechanism, set the monitoring parameters: at each time in the training process, there is a certain probability to use the output of the previous time as the input and a certain probability to use the correct target value as the input, which can improve the expansibility of the model. At the same time, if the probability is used to determine the input value in the iterative process in the training process, it can make the model have uncertainty in the training process and reduce the risk of poor performance in the evaluation process of the model.

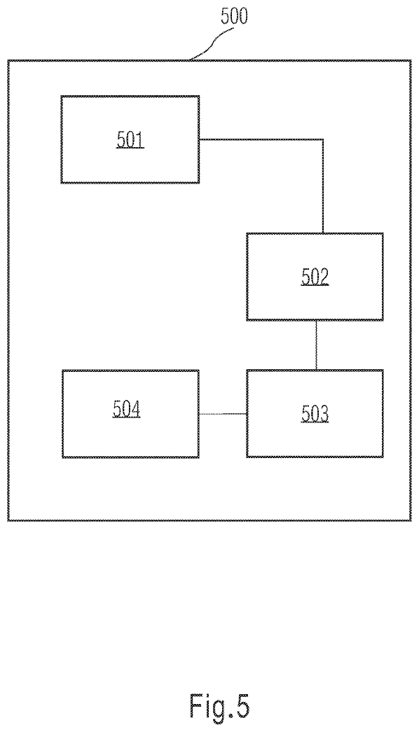

FIG. 5 is a structure diagram of an example device for predicting service life of rolling bearing incorporating teachings of the present disclosure. The device 500 for predicting service life of rolling bearing, comprises: an acquiring module 501, configured to acquire a first vibration signal of a rolling bearing; an extracting module 502, configured to extract a time-domain feature of the first vibration signal, wherein the time-domain feature represents a degradation state of the rolling bearing; an inputting module 503, configured to input the time-domain feature into a trained Seq2Seq model, the Seq2Seq model comprising an encoder and a decoder, the encoder comprising a BIGRU, the decoder comprising a LSTM, the BIGRU is adapted to output a hidden state based on the time-domain feature, the LSTM is adapted to predict service life of the rolling bearing based on the hidden state; and an outputting module 504, configured to output the service life; and an outputting module 504, configured to output the service life.

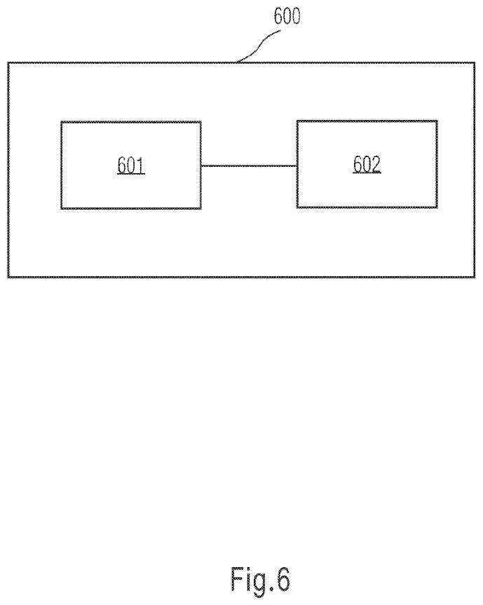

Some embodiments include an electronic device with a processor-memory architecture and adapted to perform prediction of service life of rolling bearing. FIG. 6 is a structural diagram of an example electronic device with a processor-memory architecture incorporating teachings of the present disclosure. As shown in FIG. 6, the electronic device 600 includes a processor 601, a memory 602, and a computer program stored on the memory 602 and running on the processor 601. When the computer program is executed by the processor 601, it realizes the operation of any of the methods for method for predicting service life of rolling bearing based on Seq2Seq model as described herein. Among them, the memory 602 may be implemented as various storage media such as an electrically erasable programmable read-only memory (EEPROM), a flash memory (Flash memory), and a programmable program read-only memory (PROM) The processor 601 may be implemented to include one or more central processing units or one or more field programmable gate arrays, where the field programmable gate array integrates one or more central processing unit cores. Specifically, the central processing unit or central processing unit core may be implemented as a CPU, MCU, or DSP, and so on.

Not all steps and modules in the above-mentioned processes and structural diagrams are necessary, and some steps or modules can be omitted according to actual needs. The order of execution of each step is not fixed and can be adjusted as needed. The division of each module is just to facilitate the description of the functional division. In actual implementation, a module can be implemented by multiple modules, and the functions of multiple modules can also be implemented by the same module. These modules can be located in the same device. It can also be in a different device.

The hardware modules described herein can be implemented in a mechanical way or an electronic way. For example, a hardware module may include specially designed permanent circuits or logic devices (such as dedicated processors, such as FPGAs or ASICs) to complete specific operations. The hardware module may also include programmable logic devices or circuits temporarily configured by software (for example, including general-purpose processors or other programmable processors) for performing specific operations. As for the specific use of mechanical methods, or the use of dedicated permanent circuits, or the use of temporarily configured circuits (such as software configuration) to implement hardware modules, it can be determined according to cost and time considerations.

The above are only example embodiments of the present disclosure and are not used to limit the protection scope thereof. Any modification, equivalent replacement, improvement, etc. made within the spirit and principle of the teachings of the present disclosure shall be included in the protection scope thereof.

What is claimed is:

1. A method for predicting service life of a rolling bearing, the method comprising:
acquiring a first vibration signal of a rolling bearing;
extracting a time-domain feature of the first vibration signal, wherein the time-domain feature represents a degradation state of the rolling bearing;
entering the time-domain feature into a trained Seq2Seq models comprising an encoder and a decoder, the encoder comprising a bidirectional gated recurrent unit (BIGRU), the decoder comprising a long short-term memory model (LSTM), the BIGRU adapted to put out a hidden state based on the time-domain feature, the LSTM is adapted to predict service life of the rolling bearing based on the hidden state; and
generating the service life.

2. The method according to claim 1, wherein:
the encoder further comprises a convolutional neural network;
the output of the convolutional neural network relates to the input of the BIGRU; and
the convolutional neural network is adapted to perform feature compression on the time-domain feature.

3. The method according to claim 1, wherein putting out the hidden state based on the time-domain feature comprises:
obtaining a forward hidden state through a forward time cycle layer;
obtaining a reverse hidden state through a reverse time cycle layer; and
splicing the forward hidden state and the reverse hidden state to obtain the hidden state.

4. The method according to claim 1, wherein:
the decoder further comprises an attention mechanism;
the output of the attention mechanism relates to the input of the LSTM; and
the attention mechanism is adapted to perform weighted summation of the hidden state.

5. The method according to claim 1, further comprising:
acquiring a second vibration signal of the rolling bearing;
dividing the second vibration signal into a train set and a test set;
training the Seq2Seq model based on the train set;
using the test set to test the Seq2Seq model trained based on the train set.

6. The method according to claim 5, wherein training the Seq2Seq model based on the train set comprises:
taking RMSE as the loss function of the training, wherein
$$RMSE = \sqrt{\frac{1}{n} {\sum }_{i = 1}^{n} {( {\hat{y}}_{i} - {y}_{i} )}^{2}} ;$$
wherein n is the number of training samples in the train set; i is the index of training samples; ŷᵢ is predicted value of service life; yᵢ is actual value of service life.

7. The method according to claim 5, wherein using the test set to test the Seq2Seq model trained based on the train set comprises:
taking MAE as evaluation function of the testing, wherein
$$MAE = \frac{1}{n} {\sum }_{i = 1}^{n} \vert {\hat{y}}_{i} - {y}_{i} \vert ;$$
wherein n is the number of testing samples in the test set; i is the index of testing samples; ŷᵢ is predicted value of service life; yᵢ is actual value of service life.

8. The method according to claim 5, further comprising:
denoising the second vibration signal with discrete wavelet changes; and
performing rolling segmentation on the denoised second vibration signal based on window length of a preset sliding window.

9. The method according to claim 1, wherein the time-domain feature comprises at least one of the following:
mean value; variance; root mean square amplitude; root mean square value; maximum value; minimum value; waveform index; peak index; pulse index; marginal index; skewness; and kurtosis.

10. A device for predicting service life of a rolling bearing, the device comprising:
an acquiring module to acquire a first vibration signal of a rolling bearing;
an extracting module to extract a time-domain feature of the first vibration signal, wherein the time-domain feature represents a degradation state of the rolling bearing;
a communications module to enter the time-domain feature into a trained Seq2Seq model, the Seq2Seq model comprising an encoder and a decoder, the encoder comprising a bidirectional gated recurrent unit (BIGRU), the decoder comprising a long short-term memory model (LSTM), the BIGRU adapted to generate a hidden state based on the time-domain feature, the LSTM adapted to predict service life of the rolling bearing based on the hidden state; and
a communications module to put out the service life.

11-13. (canceled)
